(19) United States
(12) Patent Application Publication
(10) Pub. No.: US 2007/0217059 A1
(43) Pub. Date: Sep. 20, 2007

(54) Storage device, control device, and control method

(75) Inventor: Takeshi Hara, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/484,538

(22) Filed: Jul. 11, 2006

(30) Foreign Application Priority Data
Mar. 20, 2006 (JP) 2006-076620

(51) Int. Cl. G11B 5/596

(52) U.S. Cl. 360/78.04

(57) ABSTRACT

Data access is performed to a storage medium having storage areas each having a data portion in that data is stored and an attached portion attached to the data portion. Each attached portion has a data pattern corresponding to a type of access capability and stores control data used in access to the data portion. At a start of access, a type of access capability corresponding to the data pattern of the control data stored in the attached portion is determined, and access by a head is controlled by a control method corresponding to the determined type.

### BACKGROUND OF THE INVENTION

1. Field of the Invention

The present invention relates to a storage device, a control device, and a control method that perform access to data in a storage medium.

2. Description of the Related Art

With development of the information-oriented society, an amount of information goes on increasing. In accordance with the increase in amount of information, a storage device having a large capacity and a low price is required to be developed. In particular, a magnetic disk to which information access is performed by a magnetic field attracts attention as an information rewritable high-density storage medium. A magnetic device which incorporates a magnetic disk and a head therein and performs information access to the magnetic disk is actively researched and developed for a large capacity.

In a general magnetic disk device, a magnetic field is applied to a magnetic disk through a head to record information such that a magnetizing direction of a recording film formed on a surface of the magnetic disk corresponds to the information. As a method to improve a capacity of the magnetic disk device, TPI (the number of tracks per inch) of the magnetic disk is increased. However, in this case, since a distance (track pitch) between adjacent tracks decreases, a highly precise head which can reliably apply a magnetic field to only a track in which information is to be written is required. For example, when TPI of the magnetic disk is set to 100 k, a track pitch is about 250 nm, and positional control in which the head motion amplitude is about ⅙ of the track pitch is required. In this manner, since the head is a very precise part, it is difficult to reliably manufacture all heads at the same precision. For this reason, of heads manufactured to obtain a precision level required for a large-storing-capacity type, a head which reaches the target precision level is used to assemble a large-storing-capacity type magnetic disk device, and a head which does not reach the target precision level is used to assemble a small-storage-capacity type magnetic disk device. As a result, for one series, magnetic disk devices with a plural of storage-capacity types are manufactured.

In a conventional technique, on a recording medium, in addition to user data serving as a target for information access, control data used for various controls such as positioning of a head is recorded. In a magnetic disk device, in order to increase a capacity and a processing speed, a storage area of a magnetic disk is divided into sectors in a circumferential direction of tracks, and servo data for controlling information access is recorded in advance at a start portion of each sector. The servo data is constituted a preamble to adjust a frequency and an amplitude, a servo mark having a data pattern common in all the sectors, a frame expressing a number of the servo data, a gray code expressing a number of a track, a burst expressing allowed motion amplitude, a postcode to correct a vibration component synchronized with rotation, and the like. The preamble is to adjust amplitude and frequency of an analog signal. Amplification or the like of the analog signal is controlled while the preamble is read. Subsequently, the data pattern of the servo mark is detected to acquire a reference position to read the subsequent frame, gray code, burst, and postcode. In this manner, the head acquires the servo data before information access, and positional control or the like is performed on the basis of the acquired servo data.

In a magnetic disk device having a large storage capacity, a head position must be controlled at a high precision by elongating the burst, and a periodical vibration component of the head must be corrected by using the postcode. However, in a magnetic disk device having a small storage capacity, positional control precision required for a head is low because a track pitch is relatively large. For this reason, a postcode in servo data is omitted, or a data length of a burst is shortened, so that a data area storing user data is stored to which information access is actually performed is preferably increased. In this manner, the servo data has different optimum formats depending on the storage capacities or the like of magnetic disk devices. However, in order to read servo data through a head, a format of the servo data must be recognized through the head in advance. For this reason, in magnetic disk devices of the same series, servo data are often written in a format common in storage-capacity types. Therefore, data areas may be decrease in vain, or processing capabilities of the magnetic disk devices cannot be sufficiently brought out, and the capabilities are deteriorated.

Furthermore, in information access, in addition to a preamble or a burst included in servo data, access parameters such as a cut-off frequency of a low-pass filter when user data serving as a target for the information access is read and a detection level of a peak detecting circuit must be appropriately set. These access parameters have optimum values that vary depending on storage-capacity types of magnetic disk devices. However, as in case of servo data, values common in magnetic disk devices of the same series are often set, and access precision is deteriorated.

With respect to this problem, in Japanese Patent Application Laid-open H01-43802, a technique that directly writes parameter values between an index mark (servo data) and data (user data) that is actually read or written. For example, optimum values of access parameters of magnetic disk devices are written between servo data and user data, so that access precision can be improved.

The following method may be effective. That is, servo data are written in formats appropriate to storage-capacity types, a storage-capacity type of a magnetic disk device is determined when servo data is read, and the servo data is read in a format appropriate to the determined storage-capacity type. As an example of the method, PCAs (Plastic Cell Architectures) are prepared, Pull-Up/Down states of the PCAs are associated with the storage-capacity types, respectively, a state of a PCA is read by firmware, and a storage-capacity type is determined on the basis of the read state. In Japanese Patent Application Laid-open H07-161137, a technique that arrange a nonvolatile EEPROM or the like in a magnetic disk device is described. For example, information expressing a storage-capacity type of the magnetic disk device is stored in the EEPROM, and the information stored in the EEPROM is read in advance, so that the storage-capacity type of the magnetic disk device can be determined.

However, a large number of access parameters are prepared to control information access at high precision. When the technique described in JP-A 01-43802 is applied to write the all access parameters between servo data and user data, data area in which the user data is to be recorded decreases, and recording efficiency of a magnetic disk is deteriorated. In addition, in a technique using a PCA or an EEPROM, the PCA or the EEPROM must be newly added to a magnetic disk device, and the device disadvantageously increases in price. In recent years, in addition to an increase in capacity of the storage device, price down is strongly demanded. In fact, in view of the cost and the storage capacity, in magnetic disk devices of the same series, servo data having a common format are recorded, and common access parameters are set in the present circumstances.

The problems are posed in not only a magnetic disk device. The problems are generally posed in fields using a storage device using a storage medium, a control device, and a control method.

### SUMMARY OF THE INVENTION

The present invention has been made in view of the above circumstances and provides a storage device, a control device, and a control method that can execute access by a method depending on capability of the device while suppressing an increase in cost and deterioration of recording efficiency.

According to the present invention, there is provided a storage device which performs access of data to a storage medium including a head which executes the access to a storage medium, the storage medium having storage areas, each storage area having a data portion in which data is stored and an attached portion attached to the data portion, and control data used in the access to respective data portions to which the attached portion is attached being stored in a data pattern corresponding to a type of an access capability, and a control section which acquires control data from the attached portion at a start of access to a storage area to control the access by the head, determines a type of an access capability corresponding to a data pattern of the control data, and controls the access of head by a control method depending on the determined type.

In a conventional recording medium, control data to control information access is stored. The control data generally includes one data pattern common in storage devices of the same series. In a storage device according to the present invention, data patterns are prepared as control data. Control data having a data pattern, of the data patterns, corresponding to a type of an access capability of the storage device is stored. At a start of access, control data is acquired, and access by a head is controlled by a control method corresponding to a type of access capability corresponding to the data pattern of the control data. Therefore, a PCA, an EEPROM, or the like need not be newly arranged, and precise access can be performed while suppressing an increase in cost. In the storage device according to the present invention, by using control data, both control of access by a head and determination of access capability are performed. For this reason, new data is not required to determine the access capability, and control depending on the access capability can be realized without deteriorating recording efficiency of a storage medium.

In the storage device according to the present invention, the attached portion of the storage area is preferably arranged on an upstream side of the data portion in a direction of the access, and the control data preferably expresses a start of the storage area.

In a conventional technique, a recording area of a magnetic disk is divided into sectors, and servo data to control information access is stored in each sector. A servo mark included in the servo data expresses a start of a sector, and all the sectors generally have a common data pattern. When the servo mark is used as control data according to the present invention, a conventional storage device can be directly converted to the storage device without being considerably changed. The servo mark can be reliably read because the servo marks are stored in all the sectors. The servo marks are used as control data according to the present invention to make it possible to improve redundancy.

In the storage device according to the present invention, the control section positions the head to the storage medium at a precision depending on the access capability, so that the head is preferably caused to execute the access at a recording density depending on the access capability.

As the positioning precision of the head is high, access can be executed at a high recording density.

In the storage device according to the present invention, the control section preferably determines a type of the access capability only when control data is acquired on the head at the beginning.

According to the storage device of the preferred embodiment, once access capability is determined, a determining process is omitted. For this reason, a processing speed of information access can be improved.

According to the present invention, there is provided a control device which controls a head which accesses a storage medium on which a data area in which data is stored and a servo data area attached to the data area are formed, in the servo data area, control data used in the access being stored in a data pattern corresponding to a type of the access capability, including an acquiring section which causes a head to acquire the control data from the servo data area, a determining section which determines a type of access capability corresponding to the data pattern of the control data, and a setting section which performs setting corresponding to the type of access capability determined by the determining section to a circuit attached to the head and used in recording and/or reproducing.

According to the control device of the present invention, a recording medium can be accessed by a method depending on access capability.

In the control device according to the present invention, the control data is preferably a servo mark or a gray code.

The servo mark or the gray code is used as the control data according to the present invention, so that a conventional storage device can be converted to the device according to the present invention without being considerably changed.

In the control device of the present invention, the access capability is preferably a capability depending on a recording capacity of the storage medium or a recording density of the storage medium.

As the recording capacity or the recording density of the storage medium is high, precise access is required.

According to the present invention, there is provided a control method that controls a head which accesses a storage medium on which a data area in which data is stored and a servo data area attached to the data area are formed, in the servo data area, control data used in the access being stored in a data pattern corresponding to a type of the access capability, including the acquiring step of causing the head to acquire the control data from the servo data area, the determining step of determining a type of access capability corresponding to the data pattern of the control data, and the setting step of performing setting corresponding to the type of access capability determined by the determining section to a circuit attached to the head and used in recording and/or reproducing.

According to the control method of the present invention, access can be executed by a method depending on capability of the device.

In the control method of the present invention, the control data is preferably a servo mark or a gray code.

According to an exemplary control method of the present invention, an increase in cost and deterioration of recording efficiency can be suppressed.

In the control method of the present invention, the access capability is preferably a capability depending on a recording capacity of the storage medium or a recording density of the storage medium.

According to the control method of the present invention, the storage medium can be efficiently accessed.

According to the present invention, access can be executed by a method depending on capability of the device while suppressing an increase in cost and deterioration of recording efficiency.

### BRIEF DESCRIPTION OF THE DRAWINGS

FIGS. 1A and 1B are external views of a hard disk device according to an embodiment of the present invention;

FIG. 2 is a perspective side view of the hard disk device shown in FIG. 1;

FIG. 3 is a conceptual diagram showing data stored on a magnetic disk;

FIG. 4 is a conceptual diagram showing an example of servo data stored in hard disk devices with respective storage-capacity types;

FIG. 5 is a functional block diagram of a hard disk device;

FIG. 6 is a flow chart showing a series of processes until information access is executed; and

FIGS. 7A and 7B are conceptual diagrams showing examples of data patterns of a servo mark.

### DETAILED DESCRIPTION OF THE INVENTION

An embodiment of the present invention will be described below with reference to the accompanying drawings.

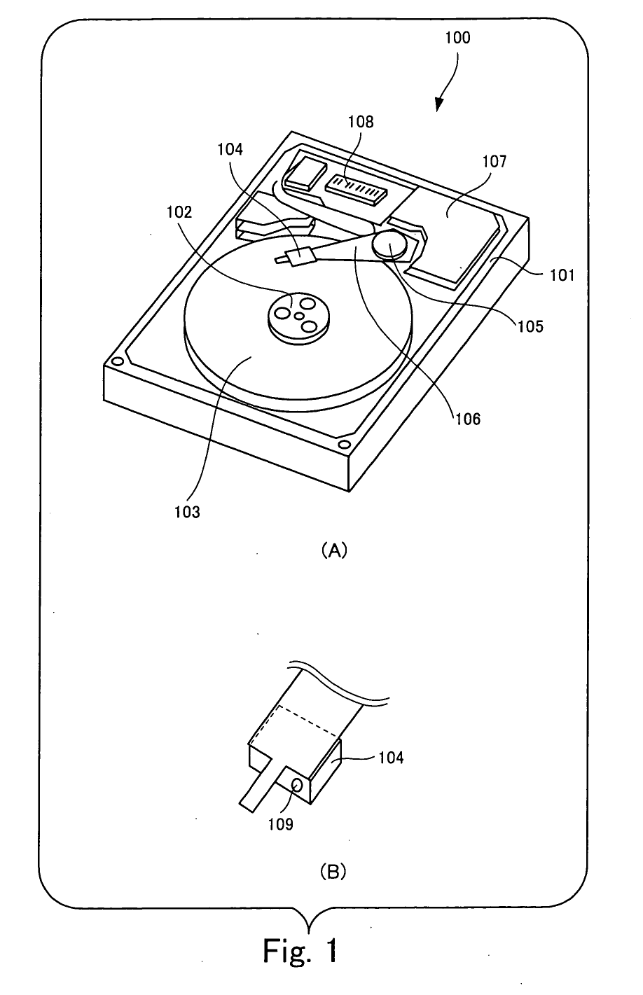

FIGS. 1A and 1B are external views of a hard disk device according to an embodiment of the present invention.

A hard disk device 100 shown in FIG. 1A corresponds to an embodiment of a storage device of the present invention. The hard disk device 100 is used such that the hard disk device 100 is connected to a host device typified by a personal computer or incorporated in the host device.

As shown in FIG. 1A, in a housing 101 of the hard disk device 100, a magnetic disk 103 having a surface on which a magnetic layer is formed, a spindle motor 102 which rotates a magnetic disk 103, a floating head slider 104 which closely faces the magnetic disk 103, an arm shaft 105, a carriage arm 106 having a distal end to which the floating head slider 104 is fixed and horizontally moving on the magnetic disk 103 about the arm shaft 105, a voice coil motor 107 which drives the carriage arm 106 to horizontally move, and a control circuit 108 which controls an operation of the hard disk device 100 are incorporated. The floating head slider 104 moves onto the magnetic disk 103 only when information access is performed to the magnetic disk 103. When the information access is not performed, the floating head slider 104 is retreated to the outside of the magnetic disk 103. As shown in FIG. 1B, a magnetic head 109 which applies a magnetic field to the magnetic disk 103 is arranged at the distal end of the floating head slider 104, and the hard disk device 100 records information on the magnetic disk 103 by using the magnetic field or reads the information recorded on the magnetic disk 103. The magnetic head 109 is an example of the head according to the present invention, and the control circuit 108 corresponds to an example of the control section according to the present invention.

Here, the explanation of the entire hard disk device 100 is interrupted, and the magnetic disk 103 and data stored in the magnetic disk 103 will be described below.

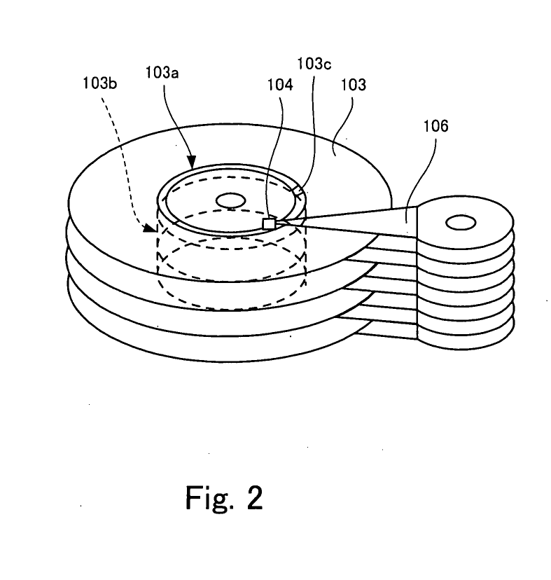

FIG. 2 is a perspective side view of the hard disk device 100 shown in FIG. 1.

In the hard disk device 100, magnetic disks 103 are arranged such that the centers of the magnetic disk 103 are adjusted to each other, and the two floating head sliders 104 which face the upper and lower surfaces of each of the magnetic disks. On the magnetic disk 103, coaxial tracks 103a are formed on the surfaces. Data is recorded along the tracks 103a. The storage medium according to the present invention may be a magnetic disk or the like on which a spiral track is formed. On the magnetic disk 103, one set of tracks 103a located at the same position is called a cylinder 103b. The magnetic disk 103 is divided into sectors 103c in a circumferential direction of the tracks 103a, and the data is accessed in units of sectors. The sector 103c corresponds to an example of the storage area according to the present invention.

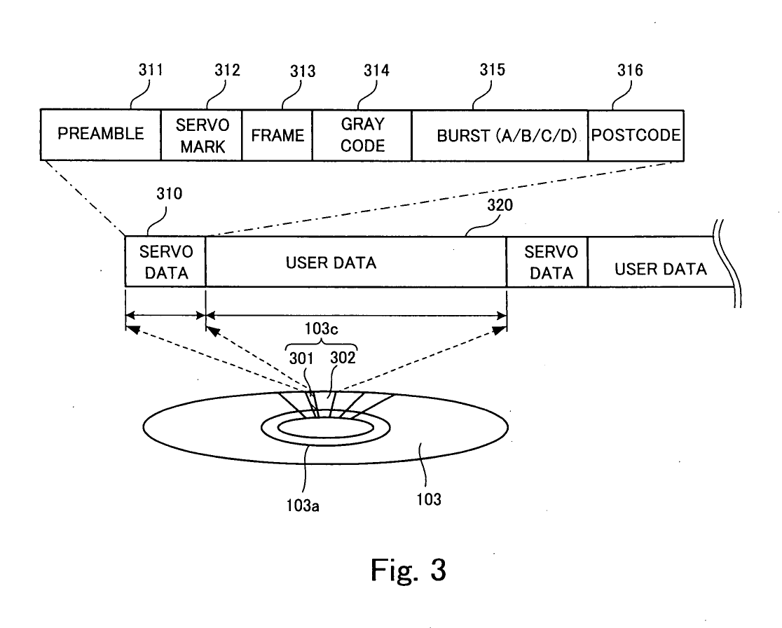

FIG. 3 is a conceptual diagram showing data stored in the magnetic disk 103.

As shown in FIG. 3, the magnetic disk 103 is divided into the sectors 103c. Servo data 310 used in positional control or the like of the magnetic head 109 and user data 320 serving as a target of access are stored along each track 103a in each sector 103c. An area portion 301 in which the user data 320 in the sector 103c is stored corresponds to examples of the data portion and the data area according to the present invention, and an area portion 302 in which the area portion 301 in the sector 103c corresponds to examples of the attached portion and the servo data area according to the present invention. The servo data 310 corresponds to an example of the control data according to the present invention.

The servo data 310 is constituted by a preamble 311 expressing an amount of amplification of a reproduced signal, a servo mark 312 expressing a start position of the servo data 310, a frame 313 expressing a serial number of the servo data 310, a gray code 314 expressing a serial number of the track 103a, a burst 315 expressing an amount of vibration allowed in the magnetic head 109, and a postcode 316 to correct a stationary vibration component synchronized with rotation. The preamble 311 is data to adjust an amplitude and a frequency of an analog signal. In fact, data subsequent to the servo mark 312 is converted into digital data. The servo mark 312 has a data pattern common in all the sectors 103c. The data pattern is acquired to detect the position of a start position (i.e., a start position of each sector 103c) of the servo data 310. The burst 315 is a parameter having a data length which increases when the precision of positional control of the magnetic head 109 is high. The postcode 316 is a parameter that is added only when the precision of the positional control of the magnetic head 109 is high.

In the steps in manufacturing the hard disk device 100, the precision of the magnetic head 109 which is a precision part does not always reach a target level. The magnetic head 109 is combined to the magnetic disk 103 having a recording density matched to the precision of the magnetic head 109 to manufacture a hard disk device. More specifically, in one series, hard disk devices 100 of storage-capacity types are manufactured. The embodiment will be described on the assumption that in one series, hard disk devices 100 of three storage-capacity types, i.e., a large-capacity type, an intermediate-capacity type, and a small-capacity type are manufactured.

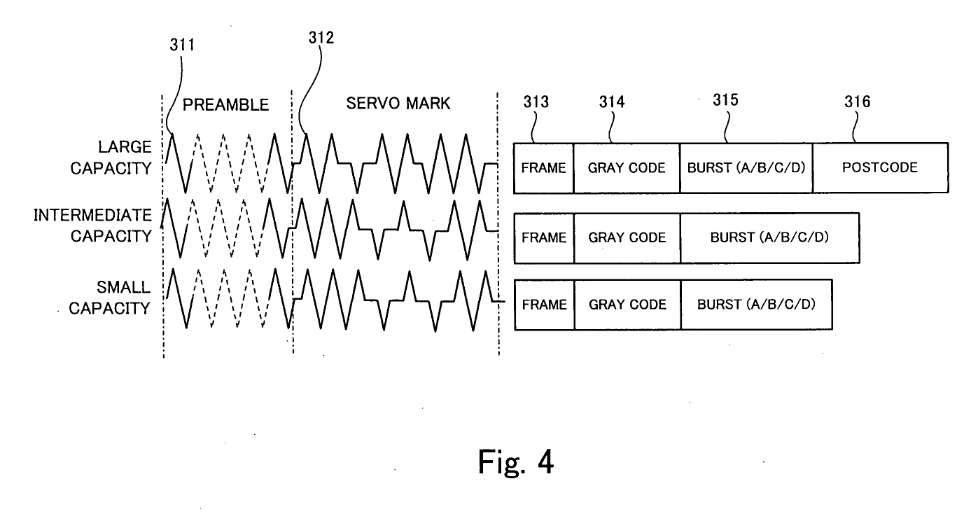

FIG. 4 is a conceptual diagram showing an example of a format of servo data.

In the hard disk device 100 of the large-capacity type, a track pitch is small because a TPI of the magnetic disk 103 is high, and the position of the magnetic head 109 must be controlled at high precision. For this reason, in the hard disk device 100 of the large-capacity type, the precise magnetic head 109 is incorporated, and the postcode 316 is added to the servo data 310, so that stationary motion amplitude of the magnetic head 109 is precisely corrected.

In the hard disk device 100 of the intermediate-capacity type, the magnetic disk 103 having an intermediate recording density and a magnetic head 109 having an intermediate precision are incorporated. Although the postcode 316 in the servo data 310 is omitted, the data size of the burst 315 is large, and motion amplitude of the magnetic head 109 is descried in detail, so that the position of the magnetic head 109 is controlled at high precision.

In the hard disk device 100 of the small-capacity type, a track pitch is relatively large because a TPI of the magnetic disk 103 is low, and precision required for positional control of the magnetic head 109 is relatively low. For this reason, a low-precision magnetic head 109 is incorporated, the postcode 316 of the servo data 310 is omitted, and the burst 315 has a small data size. In this manner, in the hard disk device of the low-storage-capacity type, the data size of the servo data 310 is suppressed to increase an occupation rate of the user data.

In the hard disk device 100, of three formats shown in FIG. 4, servo data of a format matched to the storage-capacity type of the hard disk device 100 is stored.

The entire configuration of the hard disk device 100 will be described below again.

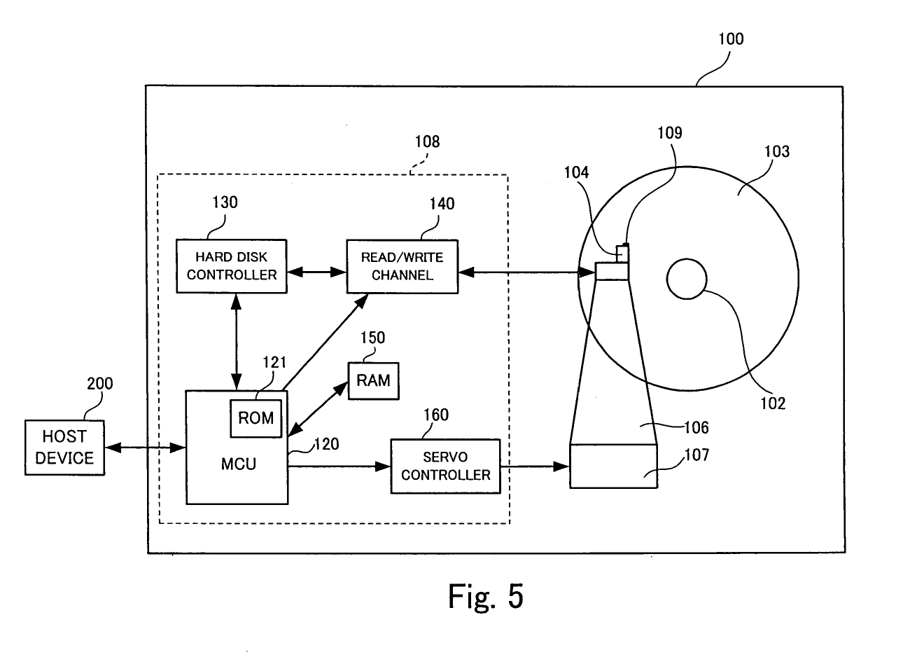

FIG. 5 is a functional block diagram of the hard disk device 100.

As typical magnetic disks and a typical slider shown in FIG. 2, one magnetic disk 103 and one floating head slider 104 arranged to face a surface of the magnetic disk 103 will be described below.

The hard disk device 100, as also shown in FIG. 1, includes the spindle motor 102, the magnetic disk 103, the floating head slider 104, the carriage arm 106, the voice coil motor 107, the control circuit 108, the magnetic head 109, and the like. The control circuit 108 communicates with a host device 200 such as a personal computer in which the hard disk device 100 is built. The control circuit 108 includes an MCU 120 which controls the hard disk device 100 as a whole, a ROM 121 in which various parameters required for information access performed by the magnetic head 109 are stored in advance, a hard disk controller 130 which controls access to the magnetic disk 103, a read/write channel 140 which generates a write current expressing recording data written in the magnetic disk 103 or converts a reproducing signal obtained by reading information recorded on the magnetic disk 103 by the magnetic head 109 into digital data, a RAM 150 used as a buffer in the MCU 120, a servo controller 160 which controls the spindle motor 102 and the voice coil motor 107, and the like. In a table of the ROM 121, three storage-capacity types (large-capacity type, intermediate-capacity type, and small-capacity type), data patterns (will be described later) of the servo marks 312 in the respective storage-capacity types, formats (see FIG. 4) of the servo data 310 in the respective storage-capacity types, and optimum values of various parameters (for example, a cutoff frequency or the like of a low-pass filter used in the read/write channel 140) in the respective storage-capacity types are stored in association with each other.

In the embodiment, the access capabilities are classified by storage-capacity types. However, the access capabilities may be classified into capabilities of a high-density type, an intermediate-density type, and a low-density type by track densities (TPI/BPI) of storage media.

In this case, when the user data 320 is accessed, the servo data 310 shown in FIG. 3 must be read in advance. The servo data 310 has a format changing depending on a storage-capacity type of the hard disk device 100. First, the data pattern of the servo mark 312 is determined to determine a storage-capacity type of the hard disk device 100. The frame 313, the gray code 314, the burst 315, and the postcode 316 subsequent to the servo mark 312 are read in a format corresponding to the storage-capacity type.

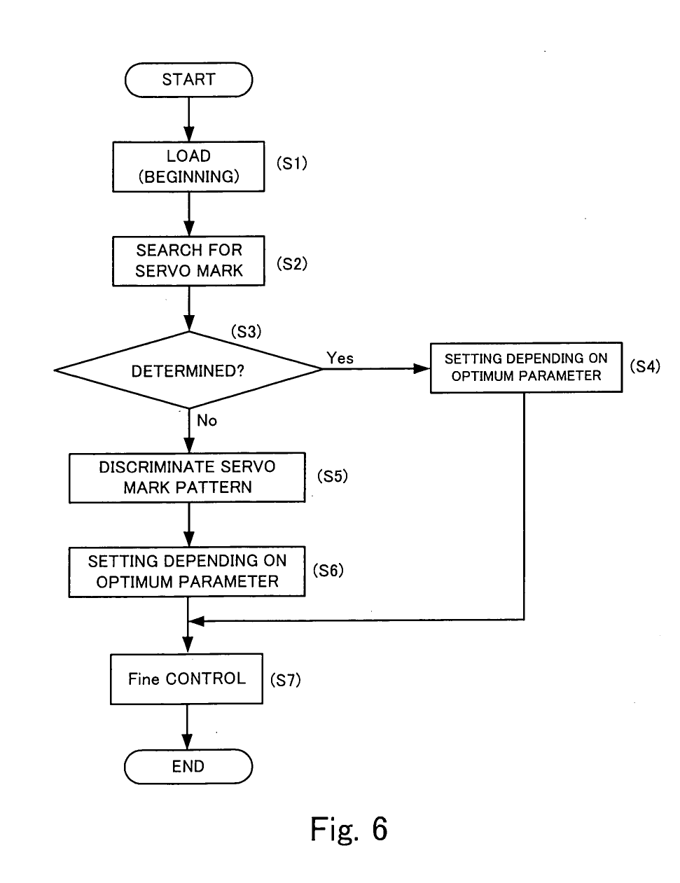

FIG. 6 is a flow chart showing a series of processes until information access is executed.

When the hard disk device 100 is powered on, data patterns of the servo marks 312 stored in the ROM 121 and associated with the three storage-capacity types (high-capacity type, intermediate-capacity type, and low-capacity type) are transmitted to the hard disk controller 130 by a firmware program in the MCU 120.

Subsequently, the firmware program in the MCU 120 transmits a designation to the servo controller 160 to move the magnetic head 109 onto the magnetic disk 103. The servo controller 160 drives the spindle motor 102 to rotate the magnetic disk 103 and drives the voice coil motor 107 to move the carriage arm 106 by a predetermined distance, so that the magnetic head 109 is moved onto the magnetic disk 103 (step S1 in FIG. 6).

The MCU 120 transmits a designation to the read/write channel 140 through the hard disk controller 130 to read data recorded on the magnetic disk 103.

In the magnetic head 109, an electrical signal reproduced corresponding to a magnetic field generated by the magnetic disk 103 is generated. The generated reproduced signal is transmitted to the read/write channel 140.

As described above, since the servo data 310 shown in FIG. 3 is recorded in each of the sectors 103c, the servo data 310 is reliably read in predetermined cycles. In the read/write channel 140, a gain and a frequency of a reproducing signal are adjusted such that the preamble 311 in the servo data 310 shown in FIG. 3 is detected at a predetermined amplitude and a predetermined frequency. The process of step 1 of acquiring the servo data 310 corresponds to an example of the acquiring step in the control method according to the present invention.

Subsequently, in the read/write channel 140, the servo mark 312 is acquired (step S2 in FIG. 6).

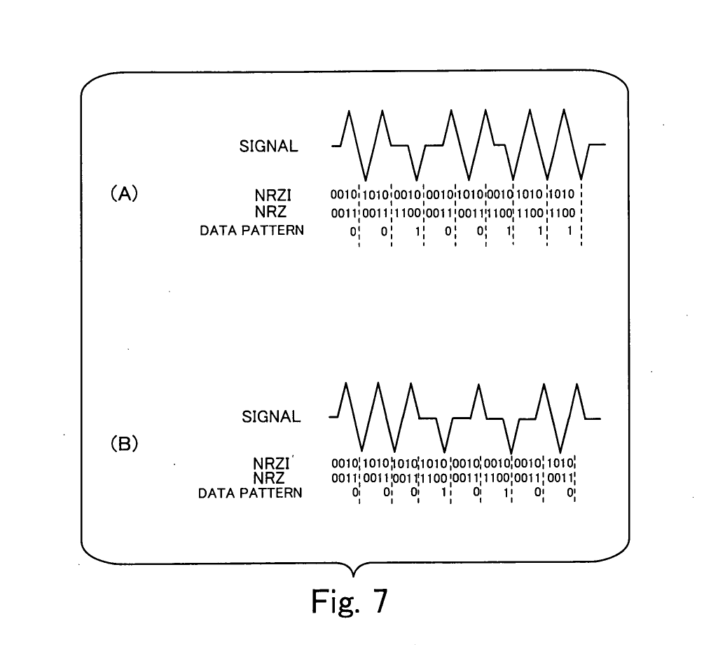

FIGS. 7A and 7B are conceptual diagrams showing examples of data patterns of a servo mark.

The read/write channel 140 cuts a signal portion (servo mark portion) subsequent to the preamble 311 in a reproduced signal read by the magnetic head 109.

Subsequently, the servo mark portion is converted into digital pattern data by the following procedure to detect a data pattern of the servo mark 312.

(1) In the servo mark portion, one cycle is divided by four, a peak and a trough of a waveform are digitized into “1”, and others are digitized into “0”, so that NRZI data is generated.

(2) In the NRZI data generated in (1), values are analyzed bit by bit from the start, the values are inverted each time “1” comes, so that NRZ data is generated.

(3) In the NRZ data, the values are determined in units of 4 bits. When a bit string is “0011”, pattern data is generated as “0” and when a bit string is “1100”, pattern data is generated as “1”.

By the procedure, a data pattern “00100111” is acquired from a servo mark portion shown in FIG. 7A. A data pattern “00010100” is acquired from a servo mark portion shown in FIG. 7B. The acquired data patterns are transmitted to the hard disk controller 130.

In this case, immediately after the device is powered on, a storage-capacity type of the hard disk device 100 is not determined (No in step S3 in FIG. 6). For this reason, in the hard disk controller 130, the data pattern of the servo mark 312 is discriminated (step S5 in FIG. 6), and a storage-capacity type is determined on the basis of the data pattern. The hard disk controller 130 specifies a data pattern matched with the data pattern of the servo mark 312 in three data patterns, and the storage-capacity type of the hard disk device 100 is determined as a storage-capacity type associated with the specified data pattern. The determined storage-capacity type is transmitted to the MCU 120. As described above, since the servo mark 312 is stored in all the sectors 103c, a storage-capacity type can be reliably determined by using the servo mark 312 which is necessarily recognized by the first seek control after the device is powered on. The process in step S3 which determines a storage-capacity type on the basis of the data pattern of the servo mark 312 corresponds to an example of the determining process in the control method according to the present invention.

The MCU 120 acquires a format and parameter values associated with the storage-capacity type transmitted from the hard disk controller 130 among the formats (see FIG. 4) and the parameter values of the servo data 310 stored in the table of the ROM 121. The acquired format and the acquired parameter values are transmitted to the read/write channel 140.

In the read/write channel 140, the format and the parameter values transmitted from the MCU 120 are registered in a cache. On the basis of the parameter values, a cut-off frequency or the like of a low-pass filter is set (step S6 in FIG. 6). The process in step S6 in which various settings are performed depending on the determined storage-capacity type corresponds to an example of the setting step in the control method according to the present invention.

After the various settings described above, information access is executed according to a designation from the host device 200 (step S7 in FIG. 6).

Since the various settings of the read/write channel 140 are performed to make it possible to read servo data, motion of the head can be controlled, and the head can be moved to an SA area (system area) which is accessed at the beginning prior to access to a user data area after the device is powered on. Analysis information of a recording surface, various pieces of control information, and the like are read from the SA area and stored in a memory, or various settings are performed to the circuits on the basis of the information. At this time, a storage-capacity type recorded in the SA area can be correctly determined. Thereafter, the data pattern of the control data (servo data or the like) need not be determined, and the information of the storage-capacity type in the determined SA determined in advance is used in various control operations.

In recording of the user data 320, a recording designation which designates recording of information, the user data 320 to be recorded, and a recording address expressing a position where the user data 320 is written on the magnetic disk 103 are transmitted from the host device 200. In reproducing of the user data 320, a reproducing designation that designates reproducing of the user data 320 and a reproducing address expressing a position where the desired user data 320 is recorded on the magnetic disk 103 are transmitted. When the recording designation is transmitted from the host device 200, the MCU 120 transmits the recording designation and the user data 320 to the hard disk controller 130 and the recording address to the servo controller 160. When the reproducing designation is transmitted from the host device 200, the MCU transmits the reproducing designation to the hard disk controller 130, and the reproducing address to the servo controller 160.

In the magnetic head 109, the user data 320 recorded on the magnetic disk 103 is read to generate a reproduced signal, and the reproduced signal is transmitted to the read/write channel 140.

In the read/write channel 140, the reproduced signal is digitized, and the servo data 310 is acquired in a format registered in a cache with reference to the position of the servo mark 312. The acquired servo data 310 is transmitted to the hard disk controller 130.

In the hard disk controller 130, a track number of the track 103a is acquired on the basis of the gray code 314 of the servo data 310, and allowed motion amplitude of the magnetic head 109 is acquired on the basis of the burst 315. When the postcode 316 is added, a steady state vibration component is acquired on the postcode 316. The acquired values are transmitted to the MCU 120.

In the MCU 120, the values transmitted from the hard disk controller 130 are transmitted to the servo controller 160. The servo controller 160 detects the position of the magnetic head 109 from the transmitted track number and the like, and moves the magnetic head 109 to a position expressed by a designated address in consideration of the transmitted allowed motion amplitude and the steady state vibration component.

When the position of the magnetic head 109 is moved, information is recorded/reproduced. When information is recorded on the magnetic disk 103, recording data transmitted to the hard disk controller 130 is transmitted to the read/write channel 140, and a write current which carries the recording data is applied from the read/write channel 140 to the magnetic head 109. In the magnetic head 109, a recording magnetic field is applied onto the magnetic disk 103 on the basis of the write current. As a result, a magnetizing direction of the recording film of the magnetic disk 103 is made equal to a direction depending on information to record information on the magnetic disk 103. In reproducing of information from the magnetic disk 103, the magnetizing direction of the magnetic disk 103 is detected by the magnetic head 109, and a generated reproducing signal is transmitted to the read/write channel 140. In the read/write channel 140, the reproducing signal is digitized to generate reproducing data. The generated reproducing data is transmitted to the MCU 120 through the hard disk controller 130 and further transmitted to the host device 200. Upon completion of the information access, the magnetic head 109 is retreated out of the magnetic disk 103.

When new information access is executed, the magnetic head 109 is moved onto the magnetic disk 103 (step S1 in FIG. 6), and the servo mark 312 is detected in the read/write channel 140 (step S2 in FIG. 6). In this step, a storage-capacity type is determined in advance (Yes in step S3 in FIG. 6), and a format and parameter values transmitted from the MCU 120 are registered in the cache of the read/write channel 140. For this reason, various setting based on the parameter values are performed (step S4 in FIG. 6). Upon completion of the various settings, the information access is actually executed (step S7 in FIG. 6). In this manner, when the storage-capacity type is determined in advance, a processing speed can be increased by omitting the determining process.

As described above, according to the hard disk device 100 of the embodiment, since a servo mark is used in both detection of a start position of servo data and determination of a storage-capacity type of the hard disk device 100, access can be realized at a precision appropriate to access capability of the storage device while suppressing deterioration of recording efficiency of the magnetic disk 103 and an increase in cost.

The embodiment explains the example in which servo data having a servo mark corresponding to a storage-capacity type of the hard disk device 100 is stored. However, as the control data according to the present invention, control data having a data pattern corresponding to access capability of the storage device may be used. For example, control data having a data pattern corresponding to a processing speed of the storage device may be used.

The embodiment explains the hard disk device that performs information access by a magnetic field. However, the storage device according to the present invention may be an optical information device or the like which performs information access to an MO disk or the like by using light. The present invention may be applied to an information storage device that performs information access to an exchangeable storage medium.

The embodiment explains the example in which servo marks each having data pattern common in all sectors are stored. The control data according to the present invention may be control data having a data pattern common in storage areas.

The embodiment explains the example in which data patterns of servo marks are changed depending on access capabilities. As the control data according to the present invention, data except for the servo mark may be used. Since the burst in the servo data area is an analog signal, pattern recognition of the burst cannot be easily performed, a bit arrangement or a frame number of a gray code of the servo data area may be changed to form data patterns.

In the present invention, heads and storage media of a high-performance (large-capacity or high-density), an intermediate-performance (intermediate-capacity or intermediate-density) type, and a low-performance (small-capacity or low-density) type may be combined to each other to constitute one device.

What is claimed is:

1. A storage device that performs access to data in a storage medium, comprising:
a head that executes the access to a storage medium, the storage medium having storage areas, each storage area having a data portion storing the data and an attached portion attached to the data portion, the attached portion storing control data used in the access to the data portion to that the attached portion is attached, and the control data being stored in a data pattern corresponding to a type of an access capability; and
a control section that causes the head to acquire the control data from the attached portion at a start of an access to the storage area to control the access by the head, determines a type of an access capability corresponding to a data pattern of the control data, and controls the access by the head by a control method depending on the determined type.

2. The storage device according to claim 1, wherein the attached portion of the storage area is arranged on an upstream side of the data portion in a direction of the access, and the control data expresses a start of the storage area.

3. The storage device according to claim 1, wherein the control section positions the head to the storage medium at a precision depending on the access capability, so that the head is caused to execute the access at a recording density depending on the access capability.

4. The storage device according to claim 1, wherein the control section determines a type of the access capability only when the control data is acquired on the head at the beginning.

5. A control device that controls a head that accesses a storage medium on that a data area in that data is stored and a servo data area attached to the data area are formed, wherein in the servo data area, control data used in the access is stored in a data pattern corresponding to a type of the access capability, and the control device further comprises:
an acquiring section that causes the head to acquire the control data from the servo data area,
a determining section that determines a type of access capability corresponding to the data pattern of the control data; and
a setting section that performs setting corresponding to the type of access capability determined by the determining section to a circuit attached to the head and used in recording and/or reproducing.

6. The control device according to claim 5, wherein the control data is a servo mark or a gray code.

7. The control device according to claim 5, wherein the access capability is a capability depending on a recording capacity of the storage medium or a recording density of the storage medium.

8. A control method that controls a head that accesses a storage medium on that a data area storing data and a servo data area attached to the data area are formed, wherein in the servo data area, control data used in the access is stored in a data pattern corresponding to a type of access capability, and the control data method further comprises:
an acquiring step that causes the head to acquire the control data from the servo data area,
a determining step that determines a type of the access capability corresponding to the data pattern of the control data, and
a setting step that performs setting corresponding to the type of the access capability determined by the determining section to a circuit attached to the head and used in recording and/or reproducing.

9. The control method according to claim 8, wherein the control data is a servo mark or a gray code.

10. The control method according to claim 8, wherein the access capability is a capability depending on a recording capacity of the storage medium or a recording density of the storage medium.
